(19) United States
(12) Patent Application Publication
(10) Pub. No.: US 2008/0150862 A1
(43) Pub. Date: Jun. 26, 2008

(54) LCD DEVICE CAPABLE OF REDUCING LINE FLICKER AND HORIZONTAL CROSSTALK FOR RGBW SUBPIXEL ARRANGEMENT

(76) Inventor: Sheng-Pin Tseng, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/616,037

(22) Filed: Dec. 26, 2006

(51) Int. Cl. G09G 3/36

(52) U.S. Cl. 345/88; 345/87

(57) ABSTRACT

An LCD device is disclosed. The LCD device includes an LCD panel, a first driving circuit, and a second driving circuit. The LCD panel includes a plurality of pixels, where each of the plurality of pixels has a plurality of subpixels corresponding to different colors and the plurality of subpixels are arranged in a matrix. The first driving circuit is electronically connected to odd data lines of the LCD panel and utilized for driving subpixels located on an active gate line and alternating polarities of pixels. The second driving circuit is electronically connected to even data lines of the LCD panel and utilized for driving subpixels located on the active gate line and alternating polarities of pixels.

### BACKGROUND OF THE INVENTION

1. Field of the Invention

The present invention relates to an LCD device, and more particularly, to an LCD device utilizing an RGBW subpixel arrangement.

2. Description of the Prior Art

In general, a primary advantage of an RGBW subpixel arrangement for a Thin-Film Transistor Liquid Crystal Display (TFT-LCD) is that an optical efficiency of the RGBW subpixel arrangement is higher than that of a conventional RGB subpixel arrangement. Furthermore, some techniques implemented on RGB system can even achieve a higher resolution and lower power consumption can be achieved simultaneously.

Although the optical efficiency of the RGBW subpixel arrangement is higher than that of the RGB subpixel arrangement, it is difficult for an LCD device utilizing the RGBW subpixel arrangement to be implemented. The difficulty is detailed as follows. Generally speaking, for the RGB subpixel arrangement, it is necessary for the driving circuit to alternately invert polarities of neighboring subpixels in horizontal direction included within pixels in an LCD panel for preventing liquid crystal cells corresponding to the pixels from horizontal crosstalk and line flicker which is caused by the same polarity of subpixels in horizontal direction. According to the RGB subpixel arrangement, a pixel comprises three subpixels corresponding to three colors (R, G, and B) respectively. The pixel polarity of a subpixel is positive (+) if a driving voltage utilized for driving the subpixel is higher than a common voltage; otherwise, the pixel polarity of the subpixel is negative (−) if the driving voltage utilized for driving the subpixel is lower than the common voltage. Usually, the common voltage has a fixed and positive voltage level. There exist many inversion schemes. One of the inversion schemes in common use is a dot inversion scheme. The idea of the dot inversion scheme is that a pixel polarity of a subpixel is opposite to those of its neighboring subpixels.

Please refer to FIG. 1. FIG. 1 is a diagram of a prior art LCD device 100 utilizing the RGB subpixel arrangement. As shown in FIG. 1, the LCD device 100 comprises a driving circuit 105 and an LCD panel 110. The LCD panel comprises a plurality of pixels 11, 12, . . . , 1n, 21, . . . , m1, . . . , etc, arranged in an m*n matrix. For simplicity, only some pixels are shown in FIG. 1, where the pixel 11 consists of subpixels R₁₁, G₁₁, B₁₁, the pixel 12 consists of subpixels R₁₂, G₁₂, B₁₂, the pixel 1n consists of subpixels R₁ₙ, G₁ₙ, B₁ₙ, the pixel 21 consists of subpixels R₂₁, G₂₁, B₂₁, and the pixel m1 consists of subpixels Rₘ₁, Gₘ₁, Bₘ₁. As can be seen, each subpixel in each pixel and corresponding subpixels with same color in neighboring pixels have opposite polarities of pixels. For example, a pixel polarity of a subpixel R₁₁ is opposite to those of adjacent subpixels R₁₂, R₂₁. Since the number of the subpixels included in a pixel is an odd number when the RGB subpixel arrangement is implemented, the driving circuit 105 can easily achieve the opposite polarities of subpixels with same color in adjacent pixels by alternately inverting the polarities of driving voltages carried by data lines D₁, D₂, . . . , and D₃ₙ corresponding to different subpixels located on a gate line and by alternately inverting the polarities of driving voltages required by different subpixels located on different gate lines corresponding to a data line D₁, D₂, . . . , or D₃ₙ. For instance, by alternately inverting polarities of driving voltages carried by data lines D₁, D₂, . . . , and D₃ₙ, the subpixel R₁₁ has a positive pixel polarity (+) and a subpixel G₁₁ has a negative pixel polarity (−); a subpixel B₁₁ has a positive pixel polarity (+) and then the subpixel R₁₂ has a negative pixel polarity (−). Similarly, by alternately inverting driving voltages required by different subpixels located on different gate lines corresponding to the data line (e.g. D₁), the subpixels R₁₁ and R₂₁ have opposite polarities of pixels.

Regarding the RGBW subpixel arrangement, however, if the same driving circuit 105 is utilized for driving subpixels directly, some undesired results are introduced. Please refer to FIG. 2. FIG. 2 is a diagram of a prior art LCD device 200 utilizing the RGBW subpixel arrangement. As shown in FIG. 2, the LCD device 200 comprises the driving circuit 105 and an LCD panel 210. The LCD panel 210 comprises a plurality of pixels 211, 212, . . . , 21n, 221, . . . , 2m1, . . . , etc, arranged in an m*n matrix. For simplicity, only some pixels are shown in FIG. 2, where the pixel 211 consists of subpixels R₂₁₁, G₂₁₁, B₂₁₁, W₂₁₁, the pixel 212 consists of subpixels R₂₁₂, G_{212, B}₂₁₂, W₂₁₂, the pixel 21 n consists of subpixels R₂₁ₙ, G₂₁ₙ, B₂₁ₙ, W₂₁ₙ, the pixel 221 consists of subpixels R₂₂₁, G₂₂₁, B₂₂₁, W₂₂₁, and the pixel 2m1 consists of subpixels R₂ₘ₁, G₂ₘ₁, B₂ₘ₁, W₂ₘ₁. Since the driving circuit 105 alternately inverts polarities of driving voltages carried by data lines D₁, D₂, . . . , and D₂ₙ corresponding to different subpixels located on a gate line and alternately inverts polarities of driving voltages required by different subpixels located on different gate lines corresponding to a data line D₁, D₂, . . . , or D₂ₙ, a pixel polarity of the subpixel R₂₁₁ is identical to those of subpixels R₂₁₂, R₂₂₁ in the adjacent pixels 212 and 221 respectively. In other words, the opposite polarities of subpixels with same color in adjacent pixels under the RGBW subpixel arrangement cannot be achieved by utilizing the above driving circuit 105 directly. This also introduces a horizontal crosstalk and a vertical crosstalk. For example, viewers may perceive an undesired red area in an image. Therefore, a scheme capable of avoiding the above-mentioned crosstalk (the horizontal crosstalk or vertical crosstalk) is very important for an LCD panel utilizing the RGBW subpixel arrangement.

### SUMMARY OF THE INVENTION

Therefore, one of the objectives of the present invention is to provide an LCD device utilizing the RGBW subpixel arrangement and capable of achieving the opposite polarities of subpixels with same color in adjacent pixels to solve the above-mentioned problems.

According to the claimed invention, an LCD device is disclosed. The LCD device comprises an LCD panel, a first driving circuit, and a second driving circuit. The LCD panel comprises a plurality of pixels, where each of the plurality of pixels has a plurality of subpixels corresponding to different colors and the plurality of subpixels are arranged in a matrix. The first driving circuit is electronically connected to odd data lines of the LCD panel and utilized for driving subpixels located on an active gate line utilizing alternating polarities of pixels. The second driving circuit is electronically connected to even data lines of the LCD panel and utilized for driving subpixels located on the active gate line utilizing alternating polarities of pixels.

According to the claimed invention, another LCD device is disclosed. The LCD device comprises an LCD panel and a driving circuit. The LCD panel comprises a plurality of pixels, where each of the plurality of pixels has a plurality of subpixels corresponding to different colors and the plurality of subpixels are arranged in a matrix. The driving circuit is electronically connected to a plurality of data lines of the LCD panel and utilized for driving subpixels located on a data line but different odd gate lines of the LCD panel utilizing alternating polarities of pixels. The driving circuit is also utilized for driving subpixels located on the data line but different even gate lines of the LCD panel utilizing alternating polarities of pixels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art LCD device utilizing the RGB subpixel arrangement.

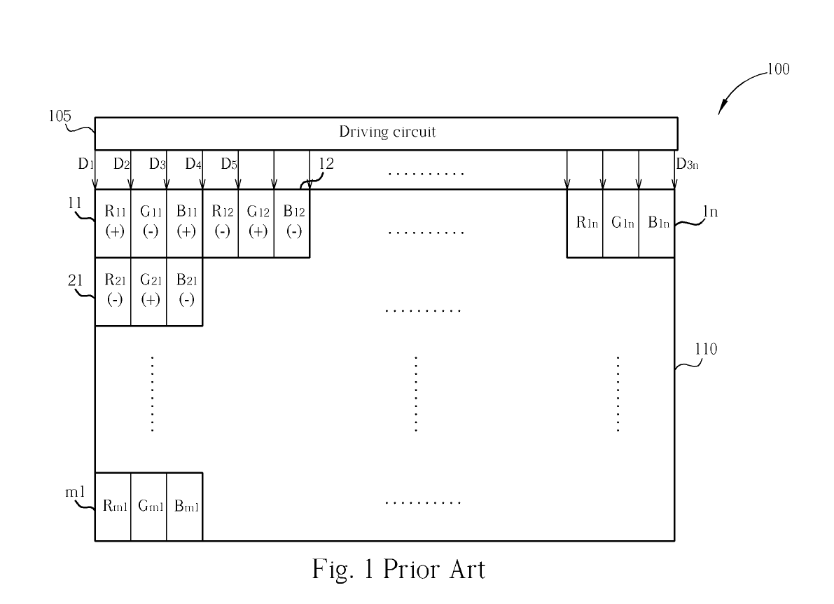

FIG. 2 is a diagram of a prior art LCD device utilizing the RGBW subpixel arrangement.

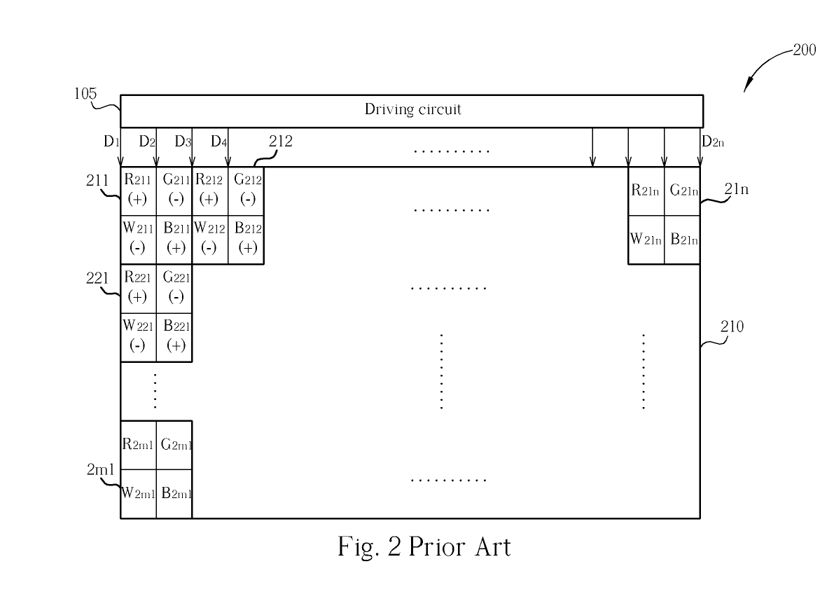

FIG. 3 is a diagram of an LCD device utilizing the RGBW subpixel arrangement according to an embodiment of the present invention.

FIG. 4 is a timing diagram showing four possible waveforms of the driving voltages outputted from the first driving circuit and the second driving circuit shown in FIG. 3 for setting polarities of pixels of corresponding subpixels located on a specific data line.

FIG. 5 is a diagram of an LCD device utilizing the RGBW subpixel arrangement according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .” The terms “couple” and “couples” are intended to mean either an indirect or a direct electrical connection. Thus, if a first device couples to a second device, that connection may be through a direct electrical connection, or through an indirect electrical connection via other devices and connections.

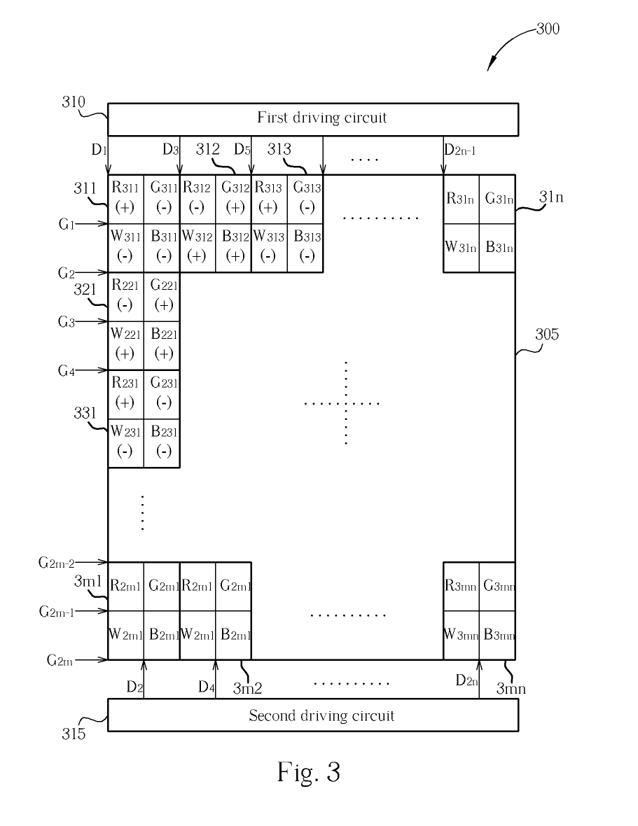

Please refer to FIG. 3. FIG. 3 is a diagram of an LCD device 300 utilizing the RGBW subpixel arrangement according to an embodiment of the present invention. As shown in FIG. 3, the LCD device 300 comprises an LCD panel 305, a first driving circuit 310, and a second driving circuit 315. The LCD panel 305 comprises a plurality of pixels 311, 312, . . . , 31n, 321, . . . , 3m1, 3m2, . . . , 3mn, arranged in an n*m matrix. Each of the pixels 311, 312, . . . , 31n, 321, . . . , 3m1, 3m2, . . . , 3mn has four subpixels corresponding to different colors: Red, Green, Blue, White; and the four subpixels are also arranged in a matrix form. The first driving circuit 310 is electronically connected to odd data lines D₁, D₃, D₅, . . . , D₂ₙ₋₁ of the LCD panel 305 and utilized for driving subpixels corresponding to the odd data lines D₁, D₃, D₅, . . . , D₂ₙ₋₁. For example, in this embodiment, the first driving circuit 310 drives the subpixels R₃₁₁, W₃₁₁, R₃₂₁, W₃₂₁, R₃₃₁, W₃₃₁, . . . , R₃ₘ₁, W₃ₘ₁, R₃₁₂, W₃₁₂, . . . , R₃ₘ₂, W₃ₘ₂, R₃₁₃, W₃₁₃, . . . , R₃₁ₙ, W₃₁ₙ, . . . , R₃ₘₙ, W₃ₘₙ. The second driving circuit 315 is electronically connected to even data lines D₂, D₄, D₆, . . . , D₂ₙ of the LCD panel 305 and utilized for driving subpixels corresponding to the even data lines D₂, D₄, D₆, . . . , D₂ₙ. For example, the second driving circuit 315 drives the subpixels G₃₁₁, B₃₁₁, G₃₂₁, B₃₂₁, G₃₃₁, B₃₃₁, . . . , G₃ₘ₁, B₃ₘ₁, G₃₂₁, B₃₁₂, . . . , G₃ₘ₂, B₃ₘ₂, G₃₁₃, B₃₁₃, . . . , G₃₁ₙ, B₃₁ₙ, . . . , G₃ₘₙ, B₃ₘₙ. It should be noted that the arrangement of subpixels included in a pixel should not be taken as a limitation of the present invention. For instance, in other embodiments, subpixels corresponding to the red or green color can be placed on even gate lines and subpixels corresponding to the white or blue color can be placed on odd gate lines, and this also obeys the spirit of the present invention.

When a specific gate line is active (e.g. the gate line G₁ is active due to high logic level “1”), the first driving circuit 310 drives the subpixels R₃₁₁, R₃₁₂, R₃₁₃, . . . , R₃₁ₙ utilizing alternating polarities of pixels, and the second driving circuit 315 drives the subpixels G₃₁₁, G₃₁₂, G₃₁₃, . . . , G₃₁ₙ utilizing alternating polarities of pixels. Similarly, when the gate line G₂ is active, the first driving circuit 310 drives the subpixels W₃₁₁, W₃₁₂, W₃₁₃, . . . , W₃₁ₙ utilizing alternating polarities of pixels, and the second driving circuit 315 drives the subpixels B₃₁₁, B₃₁₂, B₃₁₃, . . . , B₃₁ₙ utilizing alternating polarities of pixels. Taking the pixel 312 for example, the polarities of pixels of the subpixels in the pixel 312 corresponding to different colors are respectively opposite to those of the subpixels in neighboring pixels in a horizontal direction (i.e. pixels 311, 313). Identically, for other gate lines G₃˜G₂ₘ, the first driving circuit 310 also drives corresponding subpixels selected by odd data lines D₁, D₃, D₅, . . . , D₂ₙ₋₁ of the LCD panel 305, and the second driving circuit 315 drives corresponding subpixels selected by even data lines D₂, D₄, D₆, . . . , D₂ₙ. Therefore, because of an alternation of positive and negative polarities of subpixels with same color in horizontal direction, the above-mentioned horizontal crosstalk and line flicker will be alleviated or eliminated when a pure colored (a primary color or any combination of two primary colors solid box is displayed on a gray background.

For a specific odd data line (e.g. the data line D₁), the first driving circuit 310 drives subpixels selected by the data line D₁ of the LCD panel 305 but on different odd gate lines G₁, G₃, G₅˜G₂ₘ₋₁ of the LCD panel 305 utilizing alternating polarities of pixels and drives subpixels selected by the data line D₁ of the LCD panel 305 but on different even gate lines G₂, G₄, G₆˜G₂ₘ of the LCD panel 305 utilizing alternating polarities of pixels, respectively. Similarly, the second driving circuit 315 drives subpixels selected by an even data line (e.g. the data line D₂) of the LCD panel 305 but different odd gate lines G₁, G₃, G₅˜G₂ₘ₋₁ of the LCD panel 305 utilizing alternating polarities of pixels and drives subpixels selected by the data line D₂ of the LCD panel 305 but on different even gate lines G₂, G₄, G₆˜G₂ₘ of the LCD panel 305 utilizing alternating polarities of pixels, respectively. Taking the pixel 321 for example, the polarities of pixels of the subpixels in the pixel 321 corresponding to different colors are respectively opposite to those of the subpixels in its neighboring pixels in a vertical direction (i.e. pixels 311, 331). More specifically, the pixel polarity of the subpixel R₃₂₁, for instance, is opposite to those of the subpixels R₃₁₁, R₃₃₁. Identically, for other odd data lines D₃˜D₂ₙ, rules for driving corresponding subpixels selected by the data lines D₃, D₅˜D₂ₙ₋₁ are the same as that for driving the subpixels selected by the data line D₁; similarly, rules for driving corresponding subpixels selected by the data lines D₄, D₆˜D₂ₙ are the same as one for driving the subpixels selected by n the data line D₂. Therefore, because of an alternation of positive and negative polarities of subpixels with the same color in vertical directions, the above-mentioned vertical crosstalk will be alleviated or eliminated when a pure colored (a primary color or any combination of two primary colors) solid box is displayed on a gray background.

It should be noted that the pixel polarity result shown in FIG. 3 is only for illustrative purposes, and is not meant to be a limitation of the present invention. As shown in FIG. 3, on an active gate line (e.g. G₁) a subpixel driven by an odd data line (e.g. D₁) and a subpixel driven by an even data line following the odd data line (e.g. D₂) have opposite polarities of pixels. Also, on an odd data line (e.g. D₁) a subpixel selected by an odd gate line (e.g. G₁) and a subpixel selected by an even gate line following the odd gate line (e.g. G₂) have opposite polarities of pixels, and on an even data line (e.g. D₂) a subpixel selected by an odd gate line (e.g. G₁) and a subpixel selected by an even gate line following the odd gate line (e.g. G₂) have identical pixel polarity.

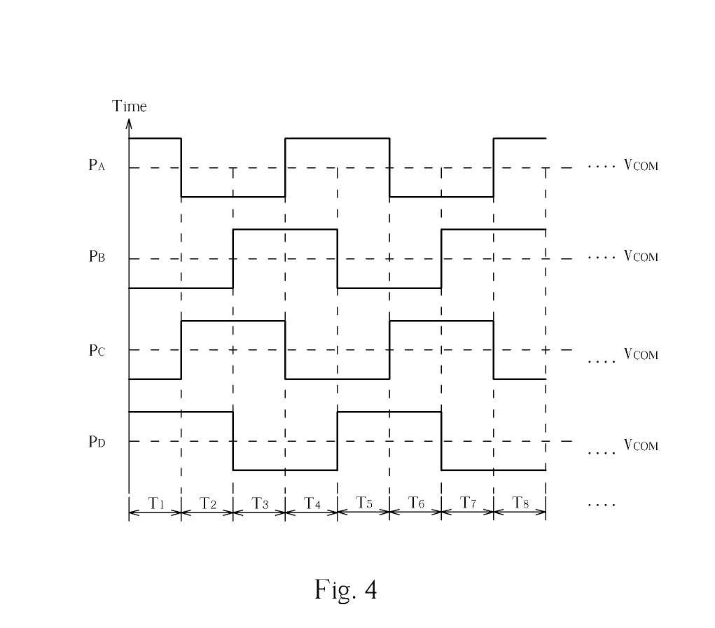

Please refer to FIG. 4. FIG. 4 is a timing diagram showing four possible waveforms P_{A}, P_{B}, P_{C}, P_{D} of the driving voltages outputted from the first driving circuits 310 and the second driving circuit 315 shown in FIG. 3 for setting polarities of pixels of corresponding subpixels located on a specific data line. The waveforms P_{A} and P_{C} are opposite and belong to a group. Similarly, the waveforms P_{B} and P_{D} are opposite and belong to another group. If the waveform of a specific data line is P_{A} in present frame, it will change to P_{C} in next frame or several frames later, and vice versa. The waveforms P_{B} and P_{D} obey the same manner. It is assumed that voltage levels of the common voltages V_{COM} corresponding to different waveforms P_{A}, P_{B}, P_{C}, P_{D} are identical. Please note that the waveforms P_{A}, P_{B}, P_{C}, P_{D} are only utilized for representing different ways of inverting polarities of pixels of subpixels selected by a data line but on different gate lines. As shown in FIG. 4, the periods T₁˜T₈ correspond, respectively, to the gate lines G₁˜G₈ shown in FIG. 3. For example, in the period T₁, the gate line G₁ is active. It is clear that the polarities of pixels of the subpixels on the data line D₁ in FIG. 3 are arranged in an order identical to the waveform P_{A}, and the polarities of pixels of the subpixels on the data line D₂ in FIG. 3 are arranged in an order identical to the waveform P_{B}. However, this is not a limitation of the present invention. In other embodiments, the polarities of pixels of the subpixels on the data line D₁ in FIG. 3 can be arranged in an order identical to one of the waveforms P_{A}, P_{B}, P_{C}, P_{D}, and the polarities of pixels of the subpixels on the data line D₂ in FIG. 3 can be arranged in an order identical to one of the waveforms P_{A}, P_{B}, P_{C}, P_{D}. Even though a subpixel driven by an odd data line and a subpixel driven by an even data line following the odd data line may have an identical pixel polarity, a horizontal crosstalk and line flicker can be reduced only if the pixel polarity of the subpixel driven by the odd data line or driven by the even data line is opposite to those of the corresponding subpixels with same color in neighboring pixels.

In other embodiments, the first driving circuit 310 is utilized for driving subpixels on an active gate line but different odd data lines by utilizing alternating polarities of pixels and for driving subpixels selected by a specific odd data line but different gate lines by utilizing alternating polarities of pixels, and the second driving circuit 315 is utilized for driving subpixels on an active gate line but different even data lines by utilizing alternating polarities of pixels and for driving subpixels selected by a specific even data line but different gate lines by utilizing alternating polarities of pixels. Although this may not avoid a vertical crosstalk, the horizontal crosstalk can be reduced or eliminated. As mentioned above, it should be noted that, for subpixels in a pixel, the polarities of the subpixels located on an active gate line and selected by an odd data line being opposite or identical to those of the subpixels on the active gate line and selected by an even data line following the odd data line are all suitable for the present invention.

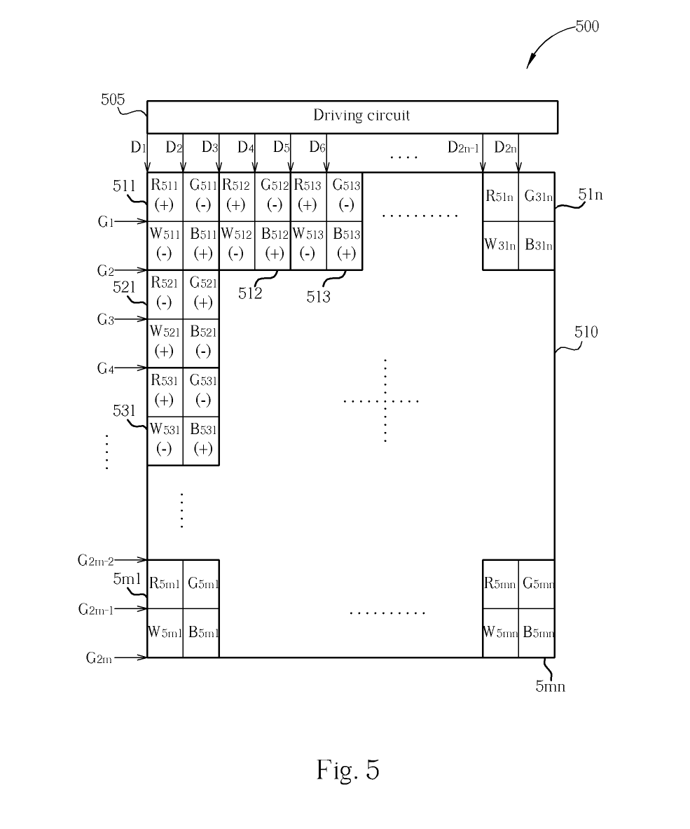

In addition, in another embodiment of the present invention, another LCD device can also achieve a goal of reducing a vertical crosstalk. Please refer to FIG. 5. FIG. 5 is a diagram of an LCD device 500 utilizing the RGBW subpixel arrangement according to another embodiment of the present invention. As shown in FIG. 5, the LCD device 500 comprises a driving circuit 505 and an LCD panel 510. The LCD panel 510 comprises a plurality of pixels 511, 512, . . . , 51n, 521, . . . , and 5m1, . . . , etc. Each of the pixels 511, 512, . . . , 51n, 521, . . . , and 5m1 , . . . , etc comprises four subpixels corresponding to different colors. For example, the pixel 511 comprises subpixels R₅₁₁, G₅₁₁, B₅₁₁, and W₅₁₁; the pixel 512 comprises subpixels R₅₁₂, G₅₁₂, B₅₁₂, and W₅₁₂ and so on. The driving circuit electronically connected to a plurality of data lines D₁˜D₂ₙ of the LCD panel 510. The driving circuit 505 is utilized for driving subpixels located on a data line (i.e. D₁, D₂, . . . , or D₂ₙ) of the LCD panel 510 but different odd gate lines G₁, G₃, G₅˜G₂ₘ₋₁ of the LCD panel 510 utilizing alternating polarities of pixels and is also utilized for driving subpixels located on the data line (i.e. D₁, D₂, . . . , or D₂ₙ) of the LCD panel 510 but different even gate lines G₂, G₄, G₆˜G₂ₘ of the LCD panel 510 utilizing alternating polarities of pixels. As shown in FIG. 5, taking subpixels selected by the data line D₁ as an example, the subpixels R₅₁₁, W₅₂₁, R₅₃₁ each have a positive pixel polarity (+) and the subpixels W₅₁₁, R₅₂₁, W₅₃₁ each have a negative pixel polarity (−). Similarly, taking subpixels selected by the data line D₂ as an example, the subpixels G₅₁₁, B₅₂₁, G₅₃₁ each have a negative pixel polarity (−) and the subpixels B₅₁₁, G₅₂₁, B₅₃₁ each have a positive pixel polarity (+). Therefore, a pixel polarity of each subpixel in a pixel is opposite to a polarity of a corresponding subpixel in its neighboring pixels in a vertical direction. For instance, the subpixel R₅₂₁, and the subpixels R₅₁₁, R₅₃₁ have opposite polarities of pixels. Thus a vertical crosstalk is reduced or eliminated. However, a horizontal crosstalk still exists since the driving circuit 505 drives subpixels on an active gate line but different data lines D₁, D₂˜D₂ₙ by utilizing alternating pixel polarity. Although the horizontal crosstalk is introduced, it is also helpful for the LCD device 500 to reduce the vertical crosstalk. This also obeys the spirit of the present invention.

Please note that, in this embodiment, the polarities of pixels of the subpixels selected by the data line D₁ in FIG. 5 are arranged in an order identical to the waveform P_{A} and the polarities of pixels of the subpixels selected by the data line D₂ in FIG. 5 are arranged in an order identical to the waveform P_{C} being inverted to the waveform P_{A}. The polarities of pixels of the subpixels selected by the data lines D₃˜D₂ₙ in FIG. 5 are arranged in other corresponding orders and so forth. However, this is not a limitation of the present invention. The polarities of pixels of the subpixels selected by the data line D₁ in FIG. 5 can be arranged in an order identical to one of the waveforms P_{A}, P_{B}, P_{C}, P_{D}, and the polarities of pixels of the subpixels selected by the data line D₂ in FIG. 5 are arranged in an order identical to an inverted waveform corresponding to one of the waveforms P_{A}, P_{B}, P_{C}, P_{D} selected by the data line D₁. For a specific date line, whether a subpixel on an odd gate line and a subpixel on an even gate line following the odd gate line may have an identical pixel polarity or opposite polarities of pixels, a vertical crosstalk can be reduced only if the pixel polarity of the subpixel on the odd gate line or on the even data line is opposite to those of the corresponding subpixels in its neighboring pixels.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An LCD device, comprising:
an LCD panel comprising a plurality of pixels each having a plurality of subpixels corresponding to different colors and arranged in a matrix, a plurality of odd data lines, a plurality of even data lines, and an active gate line;
a first driving circuit, electronically connected to the odd data lines of the LCD panel, for driving subpixels located on the active gate line and alternating polarities of pixels; and
a second driving circuit, electronically connected to the even data lines of the LCD panel, for driving subpixels located on the active gate line and alternating polarities of pixels.

2. The LCD device of claim 1, wherein the subpixels driven by the odd data lines and the subpixels driven by the even data lines following the odd data line have opposite polarities of pixels.

3. The LCD device of claim 1, wherein the subpixels driven by an odd data line and the subpixels driven by the even data lines following the odd data lines have identical polarities of pixels.

4. The LCD device of claim 1, wherein each of the pixels has an RGBW pixel arrangement.

5. The LCD device of claim 1, the LCD panel further comprises a plurality of odd gate lines and a plurality of even gate lines.

6. The LCD device of claim 5, wherein the first driving circuit drives subpixels on the odd data lines of the LCD panel and odd gate lines of the LCD panel and alternates polarities of pixels.

7. The LCD device of claim 5, wherein the first driving circuit drives subpixels on the odd data line of the LCD panel and even gate lines of the LCD panel and alternates polarities of pixels.

8. The LCD device of claim 5, wherein the subpixels on the odd data lines selected by the odd gate lines and the subpixels on the odd data lines selected by the even gate lines following the odd gate line have opposite polarities of pixels.

9. The LCD device of claim 5, wherein the subpixels on the odd data lines selected by the odd gate lines and the subpixels on the odd data lines selected by the even gate lines following the odd gate lines have identical polarities of pixels.

10. The LCD device of claim 5, wherein the second driving circuit drives subpixels on the even data lines of the LCD panel and the odd gate lines of the LCD panel and alternates polarities of pixels.

11. The LCD device of claim 5, wherein the second driving circuit drives subpixels on the even data line of the LCD panel and the even gate lines of the LCD panel and alternates polarities of pixels.

12. The LCD device of claim 5, wherein the subpixels on the even data lines selected by the odd gate lines and the subpixels on the even data lines selected by the even gate lines following the odd gate lines have opposite polarities of pixels.

13. The LCD device of claim 5, wherein the subpixels on the even data lines selected by the odd gate lines and the subpixels on the even data lines selected by the even gate line following the odd gate lines have identical polarities of pixels.

14. An LCD device, comprising:
an LCD panel comprising a plurality of pixels each having a plurality of subpixels corresponding to different colors and arranged in a matrix, a plurality of data lines, an active gate line, a plurality of odd gate lines, and a plurality of even gate lines; and
a driving circuit, electronically connected to the data lines of the LCD panel, for driving subpixels located on the data lines of the LCD panel and odd gate lines of the LCD panel and alternating polarities of pixels, and for driving subpixels located on the data line of the LCD panel and even gate lines of the LCD panel and alternating polarities of pixels.

15. The LCD device of claim 14, wherein each of the pixels has an RGBW pixel arrangement.

16. The LCD device of claim 14, wherein the subpixels selected by the odd gate lines and the subpixels selected by the even gate lines following the odd gate lines have opposite polarities of pixels.

17. The LCD device of claim 14, wherein the subpixels selected by the odd gate lines and the subpixels selected by the even gate lines following the odd gate lines have identical polarities of pixels.

18. An LCD device, comprising:
an LCD panel comprising a plurality of pixels each having a plurality of subpixels arranged in a matrix, a plurality of odd data lines, a plurality of even data lines, and an active gate line;
a first driving circuit for driving the subpixels defined by the active gate line and the odd data lines and alternating polarities of pixels; and
a second driving circuit for driving subpixels defined on the active gate line and the even data lines and alternating polarities of pixels.
